(19) United States
(12) Patent Application Publication
(10) Pub. No.: US 2004/0124645 A1
(43) Pub. Date: Jul. 1, 2004

(54) Deformable tubular crash box

(76) Inventor: Eric Koch, Mainz (DE)

Correspondence Address: LAURA C. HARGITT, General Motors Corporation,, Legal Staff, Mail Code 482-C23-B21, P.O. Box 300, Detroit, MI, 48265-3000, US

(21) Appl. No.: 10/727,340

(22) Filed: Dec. 3, 2003

(30) Foreign Application Priority Data
Dec. 19, 2002 (DE) 10259429.5

(51) Int. Cl. B60R 19/26

(52) U.S. Cl. 293/155

(57) ABSTRACT

A crash box is described with which a bumper is attached to the longitudinal beam of a motor vehicle. It ultimately involves segments of steel tubes which display an approximately rectangular cross section. The crash box is arranged such that in the case of a frontal impact on the bumper in the direction of the arrow a radial compression of the tubular crash box takes place.

Such crash boxes can be relatively simply produced and replaced such that a favorable repair cost results.

The invention pertains to a deformable tubular crash box between a bumper and a longitudinal beam of a motor vehicle the axis of which is aligned perpendicular to the longitudinal beam.

Such a crash box is known, e.g., from DE 197 09 171 C1. In this case several individual round tubular segments of open cross section and made of aluminum are assembled in a honeycomb pattern in such a way that an approximately trapezoidal structure results which is attached with its long side, forming the base of the trapezoid, to the longitudinal beam and with its short side opposite the base to the bumper.

A crash box has the function of deforming in the case of minor vehicle collisions and in so doing absorbing the energy of deformation such that the actual longitudinal beams of the vehicle are not involved in the deformation zone and therefore remain undamaged. To repair the damaged vehicle therefore only the deformed crash box and, naturally, the damaged bumper must be replaced.

In order for the repairs to be performed economically the crash box must be of simple construction, economical to produce and easily replaced. In addition it must be capable of absorbing high energies at a low force level.

The crash box proposed in DE 197 09 171 C1 satisfies these requirements only inadequately.

In order to obtain the honeycomb structure economically to some degree, it must be produced by the extrusion process. But even this process is still relatively costly. Since aluminum is softer than steel the material consumption is higher which in turn results in higher costs. In addition with the honeycomb structure chosen one may also miss the mark: in other words it withstands forces which can cause damage to the longitudinal beam which is therefore not effectively protected against deformations.

The invention is therefore based on the problem of devising a crash box which is simple to manufacture but also exhibits the desired deformation characteristics.

To solve this problem the invention envisages a crash box according to the general definition of claim I with the additional features that the crash box is manufactured from steel, has an open cross section, in which the base walls of the crash box face the longitudinal beam and bumper and the side walls running perpendicular to them produce a space between the longitudinal beam and the bumper, and that the transition between the walls has an arcuate shape.

Steel tubes with an open cross section are very easy to produce and are readily available in preassigned lengths as commercial products. The crash boxes are formed by cutting short segments from the tube.

Steel is a very suitable material since its bending torque can be adjusted by suitably chosen alloying constituents. Therefore relative to the intended purpose it displays better deformation characteristics than aluminum.

In DE 197 36 839 A1 tubular deformation elements of steel are indeed described but are not used as crash boxes for the longitudinal beams of vehicles but rather as force-absorbing elements in a flat structure, e.g., a vehicle door. The transition between the base walls and the side walls in these deformation elements follows a bending pattern. This leads to a deformation characteristic provided with force peaks: the bend may resist a force for a relatively long time but then suddenly yield. An arcuate transition as envisaged by the present invention assures a gradual increase in force since an arch quasi uncoils as resistance remains the same on its counterpart (bumper or longitudinal beam).

The deformation characteristic can be further improved if the side walls themselves, relative to the cross section of the crash box, run in an arch. In this case one obtains an especially soft transition.

A further improvement is obtained if the arch runs convexly to the inside toward the axis of the crash box. In this way the side walls are quasi thrice deflected 180° so that a total of three arches are created which absorb the deformation forces very uniformly.

A deformation characteristic with a constant increase is achieved if at least one of the base walls is pulled in convexly to the inside in the direction of the axis of the crash box at least once following an arcuate path. In this case first the side walls bend out until the zenith of the arch collides with the opposite base wall so that the side walls of this arch are drawn into the deformation.

The invention will be explained below in greater detail with reference to examples of embodiment:

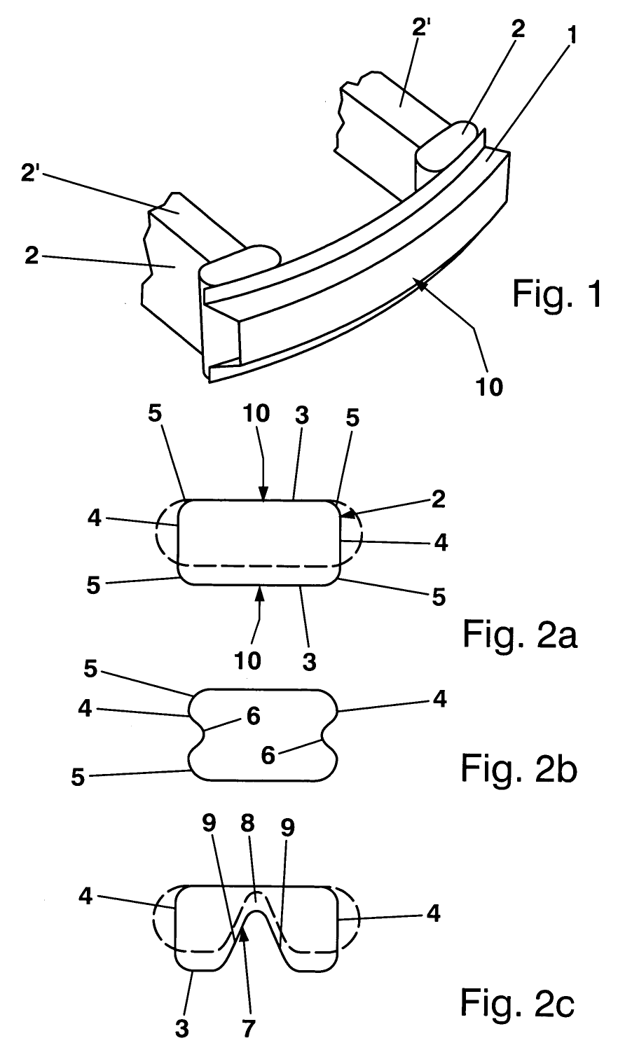

FIG. 1 shows a perspective view of a bumper with two crash boxes according to the invention,

FIGS. 2a-c shows different cross sectional shapes of the crash box.

First with reference to FIG. 1 which shows a bumper 1 or its beam which extends transversely from the front of a motor vehicle not shown in detail here.

In the longitudinal direction of the vehicle are two longitudinal beams 2′ shown here only schematically, which lead to the front of the vehicle. At their ends in each case a crash box 2 is positioned to whose front sides the beam of the bumper 1 is attached. The variant shown here concerns the front of the vehicle. The invention can, however, also be used correspondingly for the rear of the vehicle.

Each crash box 2 is formed by short tube segment with an approximately rectangular cross section. The interior of the tube segment is hollow and has no cross walls. The crash box 2 is open at the top and bottom. The cross section can be round, oval or polygonal.

In the present example of embodiment the crash boxes 2 are arranged vertically, i.e., their longitudinal axis extends vertically. However, the same effect is achieved if the crash box is aligned in a different orientation, e.g., horizontally. At any rate the axis of the crash box 2 should run transversely to the longitudinal axis of the vehicle longitudinal beam 2′ so that the crash box 2 is radially loaded.

FIG. 2a shows a first cross section of the crash box 2. This involves a rectangle with long base walls 3 and short side walls 4, where the base walls 3 are attached to the bumper or to the longitudinal beam in question. The transitions 5 between the walls 3, 4 run in an arch. If the crash box 2 corresponding to the double arrow 10 is compressed, the side walls 4 bend outward, at which time the arcuate transitions 5 are pressed out forming an arch. This situation is indicated by a dash dotted line.

In FIG. 2b the sides walls 4 are pulled into an arch 6 toward the inside. This has the advantage that the deformation of the side walls 4 is also very uniform. As a result of the S-shaped curve of the side wall 4, in other words, several arches are involved in the deformation.

With the variant shown in FIG. 2 a stepwise deformation characteristic can be achieved. In this example of embodiment one of the base walls 3, preferably that which is attached to the longitudinal beam 2′, is provided with an arch 7 extending far into the crash box which comes clearly closer to the opposite base wall. However, a small gap or space 8 remains.

In this variant first the crash box 4 deforms as is indicated in FIG. 2a. When the zenith of the arch 7 has reached the opposite base wall the side walls 9 of the arch 7 become involved in the deformation so that now a total of four walls (4, 9) are deformed and a corresponding number of arcuate transitions are formed. In this way the resistance increases so that on the whole a deformation resistance ascending in steps is achieved.

Generally it should be noted that on the unstressed parts of the crash box 2 parts for additional functions can be welded or molded on. For this purpose, in particular, the straps bridging the opening may be installed, especially in the side openings of the crash box.

1. A deformable tubular crash box between a bumper and a longitudinal beam of a motor vehicle the axis of which is aligned perpendicularly to the longitudinal beam, characterized by the fact that the crash box is manufactured from steel, has an open cross section, base walls of the crash box being arranged facing the longitudinal beam and the bumper respectively, and side walls running perpendicular to the base walls create a space between the longitudinal beam and the bumper, and that the transition between the base and side walls has an arcuate shape.

2. The crash box as in claim 1, characterized by the fact that the side walls run in an arch relative to the cross section of the crash box.

3. The crash box as in claim 2, characterized by the fact that the arch is directed convexly to the inside.

4. The crash box as in claim 1, characterized by the fact that at least one base wall is directed convexly to the inside relative to the cross section of the crash box in an arch.

5. The crash box as in claim 4, characterized by the fact that the zenith of the arch exhibits a distance from the opposite base wall that is clearly shorter than the maximal deformation path of the crash box.

6. The crash box as in claim 1, characterized by the fact that the base walls are attached to the longitudinal beam and to the bumper respectively.
